(19) United States
(12) Patent Application Publication
(10) Pub. No.: US 2013/0264816 A1
(43) Pub. Date: Oct. 10, 2013

(54) PIPE CONNECTION SYSTEM AND METHOD FOR PRODUCING A PIPE CONNECTION SYSTEM OF THIS TYPE

(71) Applicants: A. SCHULMAN GMBH, Kerpen (Sindorf) (DE); AFT AUTOMOTIVE GMBH & CO. KG, Nordwalde (DE)

(72) Inventors: Hermann CICHOREK, Gieboldehausen (DE); Andreas MAERTEN, Noerten-Hardenberg (DE); Dirk KRAMER, Havixbeck OT Hohenholte (DE); Thilo STIER, Niederkassel (DE); Peter SEBOE, Frankfurt am Main (DE)

(21) Appl. No.: 13/856,936

(22) Filed: Apr. 4, 2013

(30) Foreign Application Priority Data
Apr. 5, 2012 (DE) 10 2012 007 033.0

(51) Int. Cl. F16L 58/02

(52) U.S. Cl. CPC F16L 58/02
USPC 285/55; 156/86; 156/293

(57) ABSTRACT

A pipe connection system and method of forming the pipe connection system. The pipe connection system includes at least one tubular conducting element including an inner pipe and an outer casing and at least one coupling element including an inner component and a coating. The at least one tubular conducting element and the at least one coupling element respectively include plastic and are connected to one another. Further, the coating is welded to the outer casing and the inner pipe is welded to the inner component.

### CROSS-REFERENCE TO RELATED APPLICATIONS

The present application claims priority under 35 U.S.C. §119 of German Patent Application No. 10 2012 007 033.0 filed Apr. 5, 2012, the disclosure of which is expressly incorporated by reference herein in its entirety.

### BACKGROUND OF THE INVENTION

1. Field of the Invention

The invention relates to a pipe connection system having at least one tubular conducting element and at least one coupling element which respectively include plastic and are connected to one another.

Furthermore, the invention relates to a method for producing a pipe connection system of this type.

2. Discussion of Background Information

Pipe connection systems are generally known and serve to conduct fluids, in particular, liquids. Such pipe connection systems are assembled from conducting elements and coupling elements, in which the coupling element can likewise be embodied or formed as a tubular conducting element.

Pipe connection systems must meet many demands. They must be chemically resistant with respect to the conducted fluids and have a sufficient mechanical stability. Moreover, a diffusion barrier is frequently necessary, for example, when fuels are conducted through the pipe connection system. For highly flammable liquids and gases, e.g., fuels, a good flame protection is furthermore necessary.

### SUMMARY OF THE EMBODIMENTS OF THE INVENTION

Embodiments of the invention are directed to a pipe connection system which meets the above-described demands.

According to the embodiments, a pipe connection system of the type named at the outset includes a coupling element having an inner component and a coating, and a conducting element having an inner pipe and an outer casing. The coating is welded to the outer casing and the inner pipe is welded to the inner component.

Both the conducting element and the coupling element are assembled from multiple components. Thus, it is possible to combine materials with different properties. The inner component, the coating, the inner pipe and the outer casing can be produced from a weldable plastic. By a welding of the inner pipe to the inner component of the coupling element and by a welding of the coating to the outer casing, a 2-component to 2-component welding is obtained. In this manner, a closed connection results both on an inside and also on an outside of the pipe connection system. Through the double welding, a high tightness and mechanical stability of the pipe connection system is guaranteed.

Preferably, the conducting element bears against a front face of the coupling element. This constitutes a relatively simple embodiment. In particular, the conducting element can be embodied or formed cylinder-shaped, without needing to have a special connection geometry.

Preferably, on the front face of the coupling element, a projection is arranged which bears against an inside of the conducting element. This projection therefore extends in an axial direction from the coupling element into the inner pipe of the conducting element. Thus, there results a relatively large connection surface and a mechanically stable connection. In this way, it is guaranteed that sufficient material for the production of a materially bonded connection by welding is available.

Preferably, on the front face of the coupling element, a collar is arranged to bear against an outside of the conducting element. An end of the conducting element is inserted between the projection and the collar until it bears against the front face of the coupling element. As a result, the end of the conducting element is completely covered, such that, for example, the penetration by liquids at the end of the conducting element is prevented. In this way, there results a very large contact region between the coupling element and the conducting element to achieve a very tight and stressable connection.

Preferably, the inner pipe is embodied or formed as a multilayer pipe. Through an embodiment of this type, different properties can be combined in the inner pipe. A layer having a higher chemical resistance, e.g., can thus be combined with a layer which serves, e.g., as a diffusion barrier with respect to hydrocarbons. Moreover, a further layer can be provided that may be used for producing a secure welded connection. Additional layers, for example for increasing the mechanical stability, are likewise possible.

In a preferred embodiment, the outer casing has a flame protection durability of 3 minutes at 600° C. and of 2 minutes at 800° C. The pipe connection system is then usable for the conducting of highly flammable liquids. The outer casing should have a high glass transition temperature and a melting point of at least 250°. A material usable for the outer casing is known by the designation “Invision HT”, which was developed by co-applicant A. Schulman GmbH. The material relates to a polyamide material. The inner pipe can likewise be formed from a polyamide material. The outer casing should have a certain wall thickness for achieving the flame protection durability, e.g., between 1 and 3 mm, in particular 1.5 mm. A wall thickness of the inner pipe can be less than the wall thickness of the outer casing.

Preferably, the outer casing has an uncrosslinked plastic, such that the plastic is, in particular, an amorphous polymer. Through a structure of this type, a very high glass transition temperature with a sufficiently high flame protection durability is achieved. If necessary, an additive crosslinkable by irradiation can be added, which is activatable, e.g., by electron radiation and leads to a crosslinking of the material of the outer casing. In this way, an increased stability and a higher melting point can be achieved.

Preferably, the coating and the outer casing are formed from the same material. The desired flame protection durability thus extends over the entire pipe connection system. In this manner, it is also guaranteed that a good weldability between the coating and the outer casing is present.

Preferably, the outer casing has a lower Shore hardness and a higher impact toughness than the inner pipe, so that, in particular, the Shore hardness of the outer casing lies between Shore A 50 and Shore D 50. The pipe connection system is then well protected against mechanical influences. Because the inner pipe is protected by the outer casing, the impact toughness of the inner pipe can be lower.

Preferably, an additional outer layer is arranged on the outer casing. This outer layer can be, e.g., a braiding, a metal or a filler material. Through this outer layer, a geometric or/and an optical customization can be achieved, as well as an improvement of the mechanical stability of the pipe system.

Embodiments of the invention are directed to a method for producing a pipe connection system in which the coating of the coupling element is welded to the outer casing of the conducting element and the inner component of the coupling element is welded to the inner pipe of the conducting element.

Thus, instead of only a single welded connection, a double welded connection embodied or formed in parallel is produced. The connection concerns a so-called 2-component to 2-component welding, in which the outer components are welded to one another and the inner components to one another. Thus, there results a very tight and stressable connection. At the same time, a closed surface is obtained both on an outside and also on an inside of the pipe connection system. On the inside, this enables a high chemical resistance and diffusion blockability. On the outside, this leads to the reduction of sludge deposits and serves for example to increase a flame protection durability.

Embodiments of the invention are directed to a pipe connection system. The pipe connection system includes at least one tubular conducting element including an inner pipe and an outer casing and at least one coupling element including an inner component and a coating. The at least one tubular conducting element and the at least one coupling element respectively include plastic and are connected to one another. Further, the coating is welded to the outer casing and the inner pipe is welded to the inner component.

According to embodiments, the coupling element may include a front face and the conducting element can bear against the front face. A projection, which may be arranged on the front face, may bear against an inside of the conducting element. Moreover, a collar, which can be arranged on the front face, can bear against an outside of the conducting element.

In accordance with other embodiments, the inner pipe can include a multilayer pipe.

In embodiments, the outer casing can have a flame protection durability of 3 minutes at 600 ° C. and of 2 minutes at 800 ° C. Further, the outer casing may include an uncrosslinked plastic, and the uncrosslinked plastic can be an amorphous polymer.

According to other embodiments of the instant invention, the coating and the outer casing may be formed from a same material.

In accordance with still other embodiments, the outer casing may have a lower Shore hardness and a higher impact toughness than the inner pipe. In this regard, the Shore hardness of the outer casing can be between Shore A 50 and Shore D 50.

According to other embodiments, at least one additional outer layer can be arranged on the outer casing.

Embodiments of the invention are directed to a method for producing the above-described pipe connection system. The method includes welding the coating of the coupling element to the outer casing of the conducting element and welding the inner component of the coupling element to the inner pipe of the conducting element.

According to embodiments, the method may further include shrink fitting the outer casing onto the inner pipe.

In accordance with still other embodiments of the invention, the method can include providing a projection on the front face, and positioning the conducting element so that an inside of the conducting element bears against the projection.

In further embodiments, the method can include providing a collar on the front face, and positioning the conducting element so that an outside of the conducting element bears against the collar.

According to other embodiments of the invention, the outer casing can be formed to have a flame protection durability of 3 minutes at 600° C. and of 2 minutes at 800° C. The inner pipe can be formed to have a chemical resistance and diffusion blockability.

Embodiments of the invention are directed to a method of forming a pipe connection system. The method includes forming a coupling element having an inner component and a coating, forming a conducting element having an outer inner pipe and an outer casing, welding the coating to the outer casing, and welding the inner component to the inner pipe.

In accordance with still yet other embodiments of the present invention, the inner pipe and the outer casing may not be positively connected.

Other exemplary embodiments and advantages of the present invention may be ascertained by reviewing the present disclosure and the accompanying drawing.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 illustrates a pipe connection system with a conducting element and a coupling element in schematic view; and

FIG. 2 illustrates a sectional view of the pipe connection system shown in FIG. 1.

### DETAILED DESCRIPTION OF THE EMBODIMENTS OF THE INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied or formed in practice.

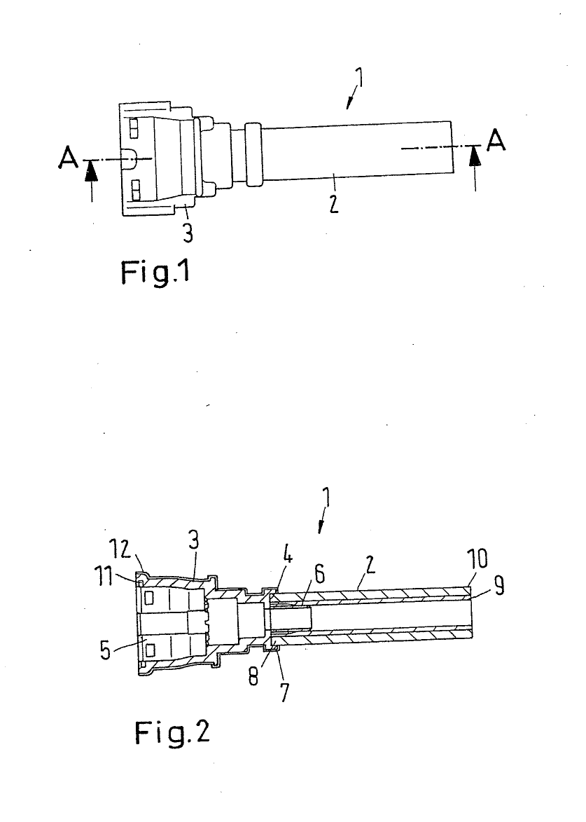

In FIG. 1, a pipe connection system 1 for the conducting of fluids is shown, in which a tubular conducting element 2 is connected to a coupling element 3. Conducting element 2 and coupling element 3 are formed from or comprise plastic and are welded to one another.

Conducting element 2 is embodied or formed cylinder-shaped and bears against a front face 4 of coupling element 3 (see FIG. 2). On an end of coupling element 3 facing away from front face 4, an insertion region 5 is provided, in which, e.g., a plug can be inserted.

Starting from front face 4, coupling element 3 has a tubular projection 6 which extends into an inside of conducting element 2. Thus, tubular projection 6 provides a large contact surface that, at the same time, enables a stable mechanical connection between coupling element 3 and conducting element 2. In this manner, projection 6 bears against an inside of conducting element 2.

A collar 7, which likewise starts from front face 4, runs parallel to projection 6. Collar 7 is radially spaced from projection 6 and bears against an outside of conducting element 2. When matched with coupling element 3, an end 8 of conducting element 2 is thus externally covered by collar 7, covered on a front face by front face 4 and internally covered by projection 6. Thus, this arrangement results in a mechanically stable and very tight connection with a relatively large contact surface between conducting element 2 and coupling element 3.

Conducting element 2 includes an inner pipe 9 and an outer casing 10. Outer casing 10 surrounds inner pipe 9 in a circumferential direction. Further, outer casing 10 can be non-positively retained, e.g., via shrink fitting onto inner pipe 9. Still further, outer casing 10 can also be simply slid in an axial direction onto inner pipe 9, in such a manner that no high retention forces act between inner pipe 9 and outer casing 10. Thus, a materially bonded connection is not provided.

Coupling element 3 has an inner component 11 and a coating 12. Inner component 11 can be or include a same material as inner pipe 9. Coating 12 can be formed from or include a same material as outer casing 10.

Coating 12 is welded to outer casing 10 and inner component 11 is welded to inner pipe 9. This therefore concerns a 2-component to 2-component welding, which guarantees a very high safety.

The material of outer casing 10 and of coating 12 in this exemplary embodiment is an uncrosslinked, amorphous polymer, which has a high flame protection durability of 3 minutes at 600° C. and of 2 minutes at 800° C. In this embodiment, a wall thickness of 1 to 2 mm is sufficient, in particular, approximately 1.5 mm.

Inner pipe 9 and thus inner component 11 can also have a polyamide which has a lower flame protection durability. For inner pipe 9 and inner component 11, a chemical resistance and diffusion blockability is instead necessary.

An exemplary embodiment is shown in which inner pipe 9 has only a single layer. However, inner pipe 9 can also be structured in a multilayered manner for achieving the desired properties.

Similarly, it is possible that additional layers are applied to outer casing 10, e.g., metallic layers, in order to enable electric conductivity, or layers for mechanical reinforcement, such as braidings or the like.

Between outer casing 10 and inner pipe 9, no or at least no high retention forces need act. A materially bonded connection is therefore not necessary. Instead, inner pipe 9 and outer casing 10 are retained in position to one another by coupling element 3, since outer casing 10 is welded to coating 12 and inner component 11 is welded to inner pipe 9. In this way, production of conducting element 2 can occur with very little cost.

It is noted that the foregoing examples have been provided merely for the purpose of explanation and are in no way to be construed as limiting of the present invention. While the present invention has been described with reference to an exemplary embodiment, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

What is claimed:

1. A pipe connection system comprising:
at least one tubular conducting element including an inner pipe and an outer casing; and
at least one coupling element including an inner component and a coating,
wherein the at least one tubular conducting element and the at least one coupling element respectively comprise plastic and are connected to one another,
wherein the coating is welded to the outer casing and the inner pipe is welded to the inner component.

2. The pipe connection system according to claim 1, wherein the coupling element comprises a front face and the conducting element bears against the front face.

3. The pipe connection system according to claim 2, wherein a projection, which is arranged on the front face, bears against an inside of the conducting element.

4. The pipe connection system according to claim 2, wherein a collar, which is arranged on the front face, bears against an outside of the conducting element.

5. The pipe connection system according to claim 1, wherein the inner pipe comprises a multilayer pipe.

6. The pipe connection system according to claim 1, wherein the outer casing has a flame protection durability of 3 minutes at 600° C. and of 2 minutes at 800° C.

7. The pipe connection system according to claim 6, wherein the outer casing comprises an uncrosslinked plastic.

8. The pipe connection system according to claim 7, wherein the uncrosslinked plastic is an amorphous polymer.

9. The pipe connection system according to claim 1, wherein the coating and the outer casing are formed from a same material.

10. The pipe connection system according to claim 1, wherein the outer casing has a lower Shore hardness and a higher impact toughness than the inner pipe.

11. The pipe connection system according to claim 10, wherein the Shore hardness of the outer casing is between Shore A 50 and Shore D 50.

12. The pipe connection system according to claim 1, further comprising at least one additional outer layer being arranged on the outer casing.

13. A method for producing the pipe connection system according to claim 1, comprising:
welding the coating of the coupling element to the outer casing of the conducting element; and
welding the inner component of the coupling element to the inner pipe of the conducting element.

14. The method according to claim 13, further comprising shrink fitting the outer casing onto the inner pipe.

15. The method according to claim 13, further comprising providing a projection on the front face, and positioning the conducting element so that an inside of the conducting element bears against the projection.

16. The method according to claim 13, further comprising providing a collar on the front face, and positioning the conducting element so that an outside of the conducting element bears against the collar.

17. The method according to claim 13, wherein the outer casing is formed to have a flame protection durability of 3 minutes at 600° C. and of 2 minutes at 800° C.

18. The method according to claim 13, wherein the inner pipe is formed to have a chemical resistance and diffusion blockability.

19. A method of forming a pipe connection system, comprising:
forming a coupling element having an inner component and a coating;
forming a conducting element having an outer inner pipe and an outer casing;
welding the coating to the outer casing; and
welding the inner component to the inner pipe.

20. The method according to claim 19, wherein the inner pipe and the outer casing are not positively connected.
